(19) United States
(12) Patent Application Publication
(10) Pub. No.: US 2025/0022176 A1
(43) Pub. Date: Jan. 16, 2025

(54) IMAGE COMPRESSION FOR HOUSEHOLD MEMBER RECOGNITION

(71) Applicant: Haier US Appliance Solutions, Inc., Wilmington, DE (US)

(72) Inventor: Michael Goodman Schroeder, Crestwood, KY (US)

(21) Appl. No.: 18/353,028

(22) Filed: Jul. 14, 2023

(51) Int. Cl. G06T 9/00; G06V 10/82; G06V 20/70; G06V 40/16

(52) U.S. Cl. CPC G06T 9/00; G06V 10/82; G06V 20/70; G06V 40/172

(57) ABSTRACT

Methods of handling an image of a member of a household may include compressing the image of the member of the household using deep image compression and storing the compressed image in a remote database. Some methods may include storing a face annotation and a caption of the image of the member of the household in the remote database. Such methods may also include decompressing the image of the member of the household. The image may be decompressed using the face annotation and the caption. The image may be decompressed using a generative neural network file-tuned to images of members of the household.

### FIELD OF THE INVENTION

The present subject matter relates generally to image compression, such as may be used with systems and methods for image-based detection and recognition of users of household appliances, and more particularly to improved image compression for images of members of a household.

### BACKGROUND OF THE INVENTION

Various devices, such as household appliances, may include features, such as a camera, for obtaining an image of a user of the device. Such devices may also be connected to remote computing devices, such as in the cloud, in order to retrieve an image of a known user and recognize the user in the obtained image based on the retrieved image of the known user.

Household appliances are utilized generally for a variety of tasks by a variety of users. For example, a household may include such appliances as laundry appliances, e.g., a washer and/or dryer, kitchen appliances, e.g., a refrigerator, a dishwasher, etc., along with room air conditioners and other various appliances.

Some household appliances may include imaging systems or camera assemblies which capture various images in and around the appliance. For example, such systems may be used to recognize a user of the household appliance. Increasingly, however, image data is being generated and stored in various forms and image sensors are increasing in output size, such as file size, e.g., of high-resolution images or increased frame rate video. As the sophistication, number, and variety of images captured by household appliances increases, the volume of associated data transmitted to, processed by, and/or stored in the cloud also increases, along with the associated costs.

Accordingly, improved features for image compression and/or decompression would be useful. More particularly, systems and methods which increase the data compression ratio of image data would be useful.

### BRIEF DESCRIPTION OF THE INVENTION

Aspects and advantages of the invention will be set forth in part in the following description, or may be apparent from the description, or may be learned through practice of the invention.

In an exemplary embodiment, a method of handling an image of a member of a household is provided. The household includes a plurality of members. The method includes storing a face annotation and a caption of the image of the member of the household in a remote database. The method also includes decompressing the image of the member of the household using the face annotation and the caption. Decompressing the reference image is performed using a generative neural network. The generative neural network is file-tuned to images of the plurality of members of the household.

In another exemplary embodiment, a method of r handling an image of a member of a household is provided. The method includes compressing the image of the member of the household using deep image compression and storing the compressed reference image in a remote database. The method also includes decompressing the image of the member of the household using a generative neural network file-tuned to images of members of the household.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of exemplary household appliances, e.g., an exemplary washing machine appliance and an exemplary dryer appliance in accordance with one or more exemplary embodiments of the present disclosure.

FIG. 2 provides a transverse cross-sectional view of the exemplary washing machine appliance of FIG. 1.

FIG. 3 provides a perspective view of the exemplary dryer appliance of FIG. 1 with portions of a cabinet of the dryer appliance removed to reveal certain components of the dryer appliance.

FIG. 4 provides a front view of a refrigerator appliance, which is another exemplary household appliance according to one or more additional exemplary embodiments of the present subject matter.

FIG. 5 provides a perspective view of the refrigerator appliance of FIG. 4.

FIG. 6 provides a front view of the refrigerator appliance of FIG. 4 with doors thereof in an open position.

FIG. 7 provides a front view of another exemplary refrigerator appliance with doors thereof in an open position according to one or more additional exemplary embodiments of the present subject matter.

FIG. 8 provides a diagrammatic illustration of a household appliance in communication with a remote computing device and with a remote user interface device according to one or more exemplary embodiments of the present subject matter.

FIG. 9 provides a flow diagram of an exemplary method of handling an image of a member of a household according to one or more exemplary embodiments of the present subject matter.

FIG. 10 provides a flow diagram of an additional exemplary method of handling an image of a member of a household according to one or more exemplary embodiments of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Directional terms such as “left” and “right” are used herein with reference to the perspective of a user standing in front of a household appliance to access the appliance and/or items therein. Terms such as “inner” and “outer” refer to relative directions with respect to the interior and exterior of the appliance. For example, “inner” or “inward” refers to the direction towards the interior of the appliance. Terms such as “left,” “right,” “front,” “back,” “top,” or “bottom” are used with reference to the perspective of a user accessing the appliance. For example, a user stands in front of the appliance to open the door(s) and reaches into the appliance to add, move, or withdraw items therein.

As used herein, the terms “first,” “second,” and “third” may be used interchangeably to distinguish one component from another and are not intended to signify location or importance of the individual components. As used herein, terms of approximation, such as “generally,” or “about” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counterclockwise. As used herein, the terms “includes” and “including” are intended to be inclusive in a manner similar to the term “comprising.” Similarly, the term “or” is generally intended to be inclusive (i.e., “A or B” is intended to mean “A or B or both”).

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

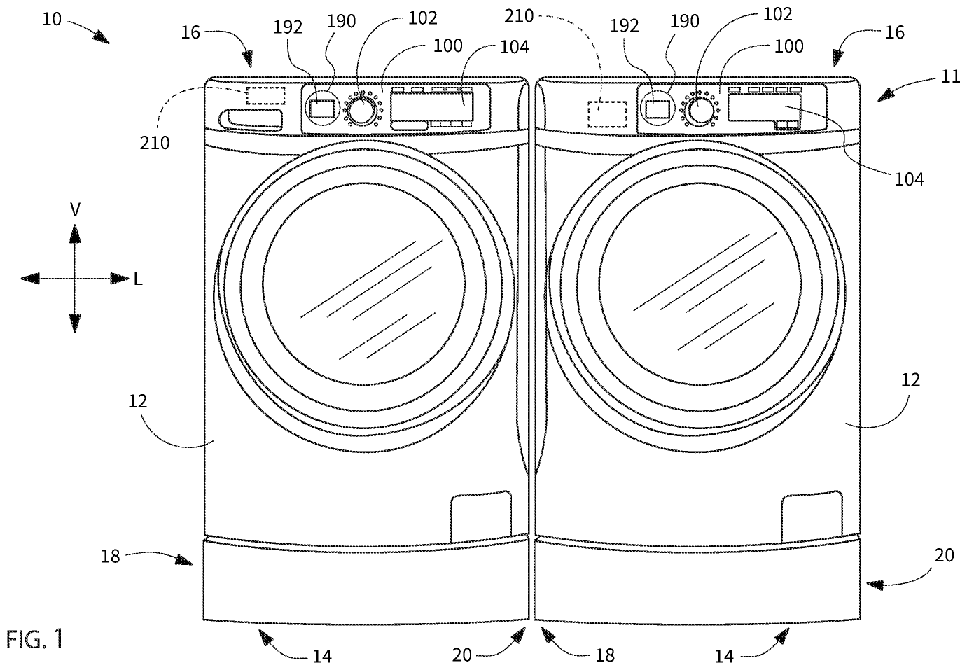

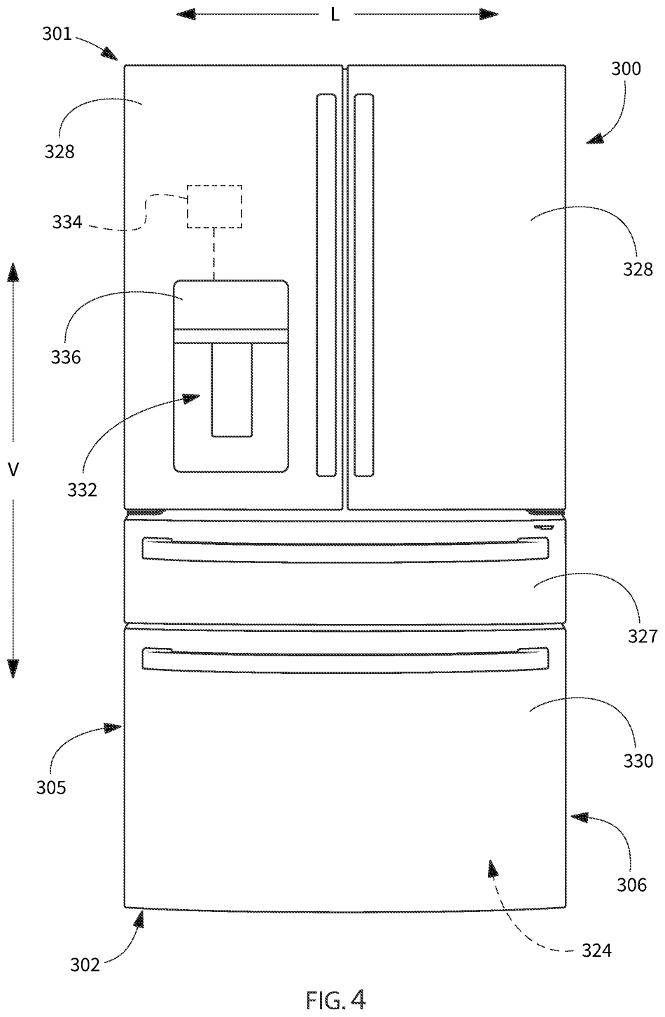

Exemplary household appliances are illustrated in FIGS. 1 through 7, e.g., the household appliance may, in various embodiments, be a laundry appliance such as a washing machine appliance or a dryer appliance as illustrated in FIGS. 1-3 or a refrigerator appliance such as the exemplary refrigerator appliance of FIGS. 4-7. In various embodiments of the present subject matter, a laundry appliance may be any suitable laundry appliance, such as a washing machine appliance, a dryer appliance, a combination washer-dryer appliance, etc. The dryer appliance 11 is separately labelled in FIG. 1 to distinguish the dryer appliance 11 from the washing machine appliance 10, where both the washing machine appliance 10 and the dryer appliance 11 are example embodiments of a household appliance 10 which may be usable in one or more exemplary methods described herein and/or may be operable and configured to perform such methods.

According to various embodiments of the present disclosure, the household appliance 10 may take the form of any of the example appliances described herein, or may be any other household appliance. Thus, it will be understood that the present subject matter is not limited to any particular household appliance.

It should be understood that “household appliance” and/or “appliance” are used herein to describe appliances typically used or intended for common domestic tasks, such as a laundry appliance, e.g., as illustrated in FIGS. 1 through 3, or an air conditioner appliance, a dishwashing appliance, a refrigerator, e.g., as illustrated in FIGS. 4 through 7, a water heater, etc., and any other household appliance which performs similar functions in addition to network communication and data processing. Thus, devices such as a personal computer, router, and other similar devices whose primary functions are network communication and/or data processing are not considered household appliances as used herein.

As may be seen generally throughout FIGS. 1 through 3, a user interface panel 100 and a user input device 102 may be positioned on an exterior of the laundry appliance. The user input device 102 is generally positioned proximate to the user interface panel 100, and in some embodiments, the user input device 102 may be positioned on the user interface panel 100.

In various embodiments, the user interface panel 100 may represent a general purpose I/O (“GPIO”) device or functional block. In some embodiments, the user interface panel 100 may include or be in operative communication with user input device 102, such as one or more of a variety of digital, analog, electrical, mechanical or electro-mechanical input devices including rotary dials, control knobs, push buttons, and touch pads. The user interface panel 100 may include a display component 104, such as a digital or analog display device designed to provide operational feedback to a user. The display component 104 may also be a touchscreen capable of receiving a user input, such that the display component 104 may also be a user input device in addition to or instead of the user input device 102.

Generally, each appliance may include a controller 210 in operative communication with the user input device 102. The user interface panel 100 and the user input device 102 may be in communication with the controller 210 via, for example, one or more signal lines or shared communication busses. Input/output (“I/O”) signals may be routed between controller 210 and various operational components of the appliance. Operation of the appliance can be regulated by the controller 210 that is operatively coupled to the user interface panel 100. A user interface panel 100 may for example provide selections for user manipulation of the operation of an appliance, e.g., via user input device 102 and/or display 104. In response to user manipulation of the user interface panel 100 and/or user input device 102, the controller 210 may operate various components of the appliance. Controller 210 may include a memory and one or more microprocessors, CPUs or the like, such as general or special purpose microprocessors operable to execute programming instructions or micro-control code associated with operation of the appliance. The memory may represent random access memory such as DRAM, or read only memory such as ROM or FLASH. In one embodiment, the processor executes programming instructions stored in memory. The memory may be a separate component from the processor or may be included onboard within the processor. Alternatively, a controller 210 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

The controller 210 may be programmed to operate the appliance by executing instructions stored in memory. For example, the instructions may be software or any set of instructions that when executed by the processing device, cause the processing device to perform operations. Controller 210 can include one or more processor(s) and associated memory device(s) configured to perform a variety of computer-implemented functions and/or instructions (e.g. performing the methods, steps, calculations and the like and storing relevant data as disclosed herein). It should be noted that controllers 210 as disclosed herein are capable of and may be operable to perform any methods and associated method steps as disclosed herein.

As generally seen throughout FIGS. 1 through 3, in at least some embodiments, each laundry appliance 10 and 11 includes a cabinet 12 which defines a vertical direction V, a lateral direction L, and a transverse direction T that are mutually perpendicular. Each cabinet 12 extends between a top side 16 and a bottom side 14 along the vertical direction V. Each cabinet 12 also extends between a left side 18 and a right side 20, e.g., along the lateral direction L, and between a front side 22 and a rear side 24 along the transverse direction T.

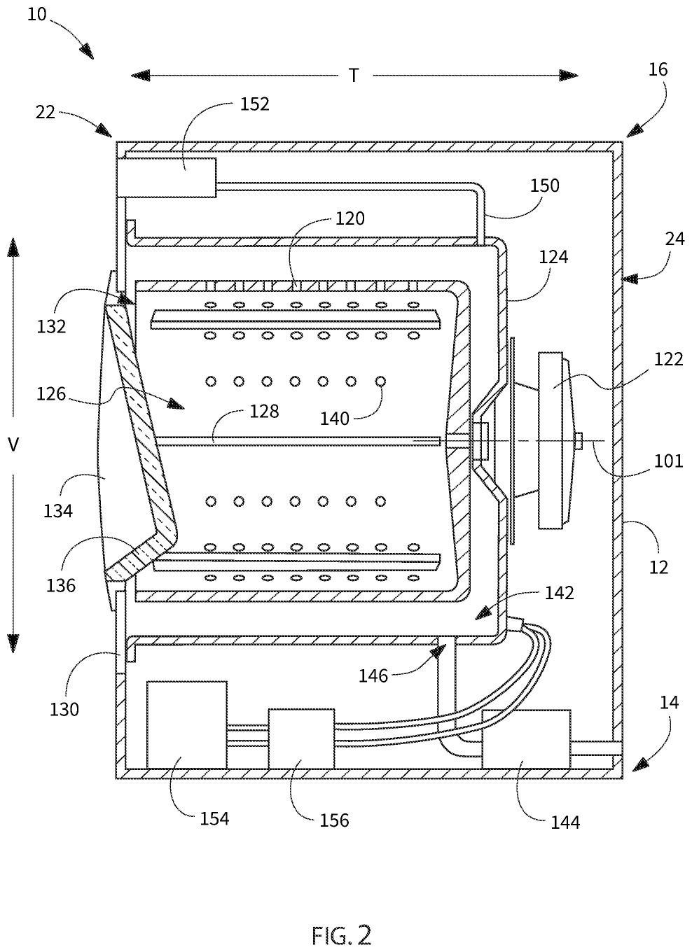

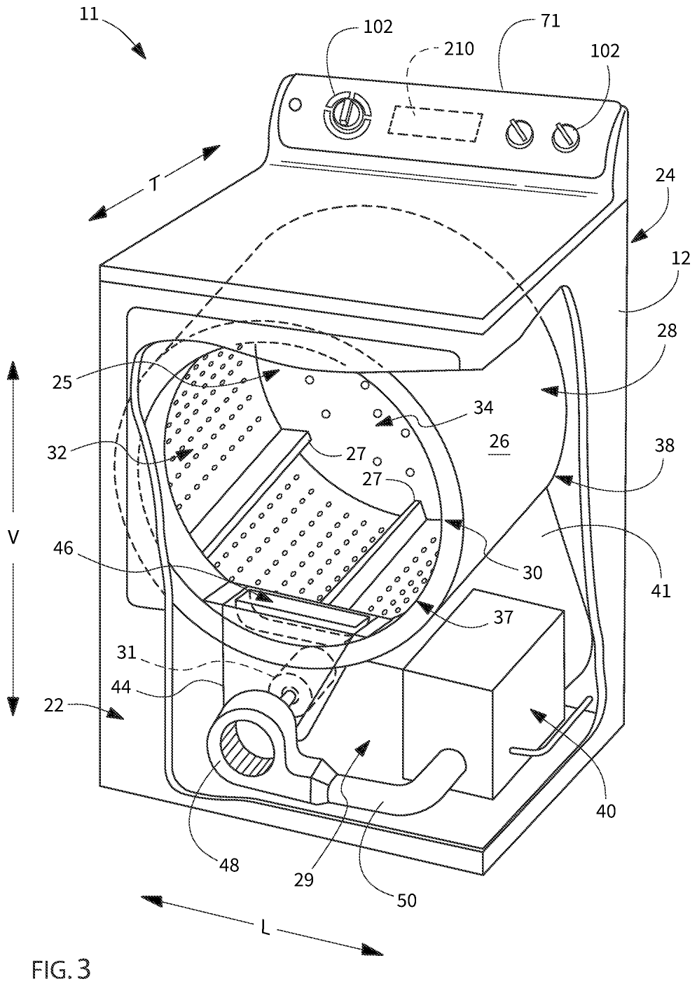

Additional exemplary details of each laundry appliance are illustrated in FIGS. 2 and 3. For example, FIG. 2 provides a cross-sectional view of the exemplary washing machine appliance 10. As illustrated in FIG. 2, a wash tub 124 is non-rotatably mounted within cabinet 12. As may be seen in FIG. 2, the wash tub 124 defines a central axis 101. In the example embodiment illustrated by FIG. 2, the central axis 101 may be oriented generally along or parallel to the transverse direction T of the washing machine appliance 10. Accordingly, the washing machine appliance 10 may be referred to as a horizontal axis washing machine.

Referring again to FIG. 2, a wash basket 120 is rotatably mounted within the tub 124 such that the wash basket 120 is rotatable about an axis of rotation, which generally coincides with central axis 101 of the tub 124. A motor 122, e.g., such as a pancake motor, is in mechanical communication with wash basket 120 to selectively rotate wash basket 120 (e.g., during an agitation or a rinse cycle of washing machine appliance 10). Wash basket 120 defines a wash chamber 126 that is configured for receipt of articles for washing. The wash tub 124 holds wash and rinse fluids for agitation in wash basket 120 within wash tub 124. As used herein, “wash fluid” may refer to water, detergent, fabric softener, bleach, or any other suitable wash additive or combination thereof. The wash basket 120 and the tub 124 may collectively define at least a portion of a tub assembly for the washing machine appliance 10.

Wash basket 120 may define one or more agitator features that extend into wash chamber 126 to assist in agitation and cleaning of articles disposed within wash chamber 126 during operation of washing machine appliance 10. For example, as illustrated in FIG. 2, a plurality of ribs 128 extends from basket 120 into wash chamber 126. In this manner, for example, ribs 128 may lift articles disposed in wash basket 120 during rotation of wash basket 120.

Referring generally to FIGS. 1 and 2, cabinet 12 also includes a front panel 130 which defines an opening 132 that permits user access to wash basket 120 within wash tub 124. More specifically, washing machine appliance 10 includes a door 134 that is positioned in front of opening 132 and is rotatably mounted to front panel 130. Door 134 is rotatable such that door 134 permits selective access to opening 132 by rotating between an open position (not shown) facilitating access to a wash tub 124 and a closed position (FIG. 1) prohibiting access to wash tub 124.

A window 136 in door 134 permits viewing of wash basket 120 when door 134 is in the closed position, e.g., during operation of washing machine appliance 10. Door 134 also includes a handle (not shown) that, e.g., a user may pull when opening and closing door 134. Further, although door 134 is illustrated as mounted to front panel 130, it should be appreciated that door 134 may be mounted to another side of cabinet 12 or any other suitable support according to alternative embodiments.

Referring again to FIG. 2, wash basket 120 also defines a plurality of perforations 140 in order to facilitate fluid communication between an interior of basket 120 and wash tub 124. A sump 142 is defined by wash tub 124 at a bottom of wash tub 124 along the vertical direction V. Thus, sump 142 is configured for receipt of and generally collects wash fluid during operation of washing machine appliance 10. For example, during operation of washing machine appliance 10, wash fluid may be urged by gravity from basket 120 to sump 142 through plurality of perforations 140. A pump assembly 144 is located beneath tub 124 for gravity assisted flow when draining tub 124, e.g., via a drain 146. Pump assembly 144 may be configured for recirculating wash fluid within wash tub 124.

A spout 150 is configured for directing a flow of fluid into wash tub 124. For example, spout 150 may be in fluid communication with a water supply (not shown) in order to direct fluid (e.g., clean water) into wash tub 124. Spout 150 may also be in fluid communication with the sump 142. For example, pump assembly 144 may direct wash fluid disposed in sump 142 to spout 150 in order to circulate wash fluid in wash tub 124.

As illustrated in FIG. 2, a detergent drawer 152 is slidably mounted within front panel 130. Detergent drawer 152 receives a wash additive (e.g., detergent, fabric softener, bleach, or any other suitable liquid or powder) and directs the fluid additive to wash chamber 124 during operation of washing machine appliance 10. According to the illustrated embodiment, detergent drawer 152 may also be fluidly coupled to spout 150 to facilitate the complete and accurate dispensing of wash additive.

Additionally, a bulk reservoir 154 is disposed within cabinet 12. Bulk reservoir 154 is also configured for receipt of fluid additive for use during operation of washing machine appliance 10. Bulk reservoir 154 is sized such that a volume of fluid additive sufficient for a plurality or multitude of wash cycles of washing machine appliance 10 (e.g., five, ten, twenty, fifty, or any other suitable number of wash cycles) may fill bulk reservoir 154. Thus, for example, a user can fill bulk reservoir 154 with fluid additive and operate washing machine appliance 10 for a plurality of wash cycles without refilling bulk reservoir 154 with fluid additive. A reservoir pump 156 is configured for selective delivery of the fluid additive from bulk reservoir 154 to wash tub 124.

During operation of washing machine appliance 10, e.g., during a wash cycle of the washing machine appliance 10, a laundry items are loaded into wash basket 120 through opening 132, and washing operation is initiated through operator manipulation of input selectors 102. Wash tub 124 is filled with water, detergent, and/or other fluid additives, e.g., via spout 150 and/or detergent drawer 152. One or more valves (not shown) can be controlled by washing machine appliance 10 to provide for filling wash basket 120 to the appropriate level for the amount of articles being washed and/or rinsed. By way of example for a wash mode, once wash basket 120 is properly filled with fluid, the contents of wash basket 120 can be agitated (e.g., with ribs 128) for washing of laundry items in wash basket 120.

After the agitation phase of the wash cycle is completed, wash tub 124 can be drained. Laundry articles can then be rinsed by again adding fluid to wash tub 124, depending on the particulars of the cleaning cycle selected by a user. Ribs 128 may again provide agitation within wash basket 120. One or more spin cycles may also be used. In particular, a spin cycle may be applied after the wash cycle and/or after the rinse cycle in order to wring wash fluid from the articles being washed. During a spin cycle, basket 120 is rotated at relatively high speeds. After articles disposed in wash basket 120 are cleaned and/or washed, the user can remove the articles from wash basket 120, e.g., by opening door 134 and reaching into wash basket 120 through opening 132.

While described in the context of a specific embodiment of horizontal axis washing machine appliance 10, using the teachings disclosed herein it will be understood that horizontal axis washing machine appliance 10 is provided by way of example only. It should be appreciated that the present subject matter is not limited to any particular style, model, or configuration of washing machine appliance. Other washing machine appliances having different configurations, different appearances, and/or different features may also be utilized with the present subject matter as well, e.g., vertical axis washing machine appliances.

FIG. 3 provides a perspective view of the dryer appliance 11 of FIG. 1, which is an example embodiment of a laundry appliance, and is an example embodiment of a household appliance 10, with a portion of a cabinet or housing 12 of dryer appliance 11 removed in order to show certain components of dryer appliance 11. Dryer appliance 11 generally defines a vertical direction V, a lateral direction L, and a transverse direction T, each of which is mutually perpendicular, such that an orthogonal coordinate system is defined. While described in the context of a specific embodiment of dryer appliance 11, using the teachings disclosed herein, it will be understood that dryer appliance 11 is provided by way of example only. Other dryer appliances having different appearances and different features may also be utilized with the present subject matter as well.

Cabinet 12 includes a front side 22 and a rear side 24 spaced apart from each other along the transverse direction T. Within cabinet 12, an interior volume 29 is defined. A drum or container 26 is mounted for rotation about a substantially horizontal axis within the interior volume 29. Drum 26 defines a chamber 25 for receipt of articles of clothing for tumbling and/or drying. Drum 26 extends between a front portion 37 and a back portion 38. Drum 26 also includes a back or rear wall 34, e.g., at back portion 38 of drum 26. A supply duct 41 may be mounted to rear wall 34 and receives heated air that has been heated by a heating assembly or system 40.

As used herein, the terms “clothing” or “articles” includes but need not be limited to fabrics, textiles, garments, linens, papers, or other items from which the extraction of moisture is desirable. Furthermore, the term “load” or “laundry load” refers to the combination of clothing or articles that may be washed together in a washing machine or dried together in a dryer appliance 11 (e.g., clothes dryer) and may include a mixture of different or similar articles of clothing of different or similar types and kinds of fabrics, textiles, garments and linens within a particular laundering process.

A motor 31 is provided in some embodiments to rotate drum 26 about the horizontal axis, e.g., via a pulley and a belt (not pictured). Drum 26 is generally cylindrical in shape, having an outer cylindrical wall 28 and a front flange or wall 30 that defines an opening 32 of drum 26, e.g., at front portion 37 of drum 26, for loading and unloading of articles into and out of chamber 25 of drum 26. A plurality of lifters or baffles 27 are provided within chamber 25 of drum 26 to lift articles therein and then allow such articles to tumble back to a bottom of drum 26 as drum 26 rotates. Baffles 27 may be mounted to drum 26 such that baffles 27 rotate with drum 26 during operation of dryer appliance 11.

The rear wall 34 of drum 26 may be rotatably supported within the cabinet 12 by a suitable fixed bearing. Rear wall 34 can be fixed or can be rotatable. Rear wall 34 may include, for instance, a plurality of holes that receive hot air that has been heated by heating system 40. The heating system 40 may include, e.g., a heat pump, an electric heating element, and/or a gas heating element (e.g., gas burner). Moisture laden, heated air is drawn from drum 26 by an air handler, such as blower fan 48, which generates a negative air pressure within drum 26. The moisture laden heated air passes through a duct 44 enclosing screen filter 46, which traps lint particles. As the air passes from blower fan 48, it enters a duct 50 and then is passed into heating system 40. In some embodiments, the dryer appliance 11 may be a conventional dryer appliance, e.g., the heating system 40 may be or include an electric heating element, e.g., a resistive heating element, or a gas-powered heating element, e.g., a gas burner. In other embodiments, the dryer appliance may be a condensation dryer, such as a heat pump dryer. In such embodiments, heating system 40 may be or include a heat pump including a sealed refrigerant circuit. Heated air (with a lower moisture content than was received from drum 26), exits heating system 40 and returns to drum 26 by duct 41. After the clothing articles have been dried, they are removed from the drum 26 via opening 32. A door (FIG. 1) provides for closing or accessing drum 26 through opening 32.

In some embodiments, one or more selector inputs 102, such as knobs, buttons, touchscreen interfaces, etc., may be provided or mounted on the cabinet 12 (e.g., on a backsplash 71) and are in operable communication (e.g., electrically coupled or coupled through a wireless network band) with the processing device or controller 210. Controller 210 may also be provided in operable communication with components of the dryer appliance 11 including motor 31, blower 48, or heating system 40. In turn, signals generated in controller 210 direct operation of motor 31, blower 48, or heating system 40 in response to the position of inputs 102. As used herein, “processing device” or “controller” may refer to one or more microprocessors, microcontroller, ASICS, or semiconductor devices and is not restricted necessarily to a single element. The controller 210 may be programmed to operate dryer appliance 11 by executing instructions stored in memory (e.g., non-transitory media). The controller 56 may include, or be associated with, one or more memory elements such as RAM, ROM, or electrically erasable, programmable read only memory (EEPROM). For example, the instructions may be software or any set of instructions that when executed by the processing device, cause the processing device to perform operations. It should be noted that controllers as disclosed herein are capable of and may be operable to perform any methods and associated method steps as disclosed herein. For example, in some embodiments, methods disclosed herein may be embodied in programming instructions stored in the memory and executed by the controller 210.

Turning now to FIGS. 4 through 7, in some embodiments, the household appliance 10 may be a refrigerator appliance such as the exemplary refrigerator appliances 300 illustrated in FIGS. 4 through 7.

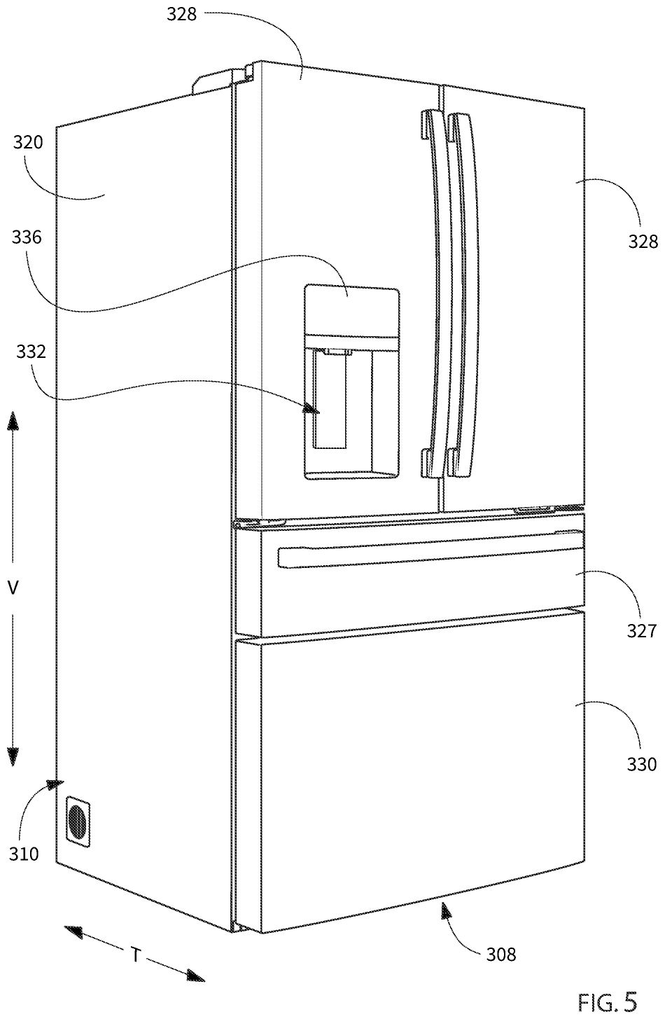

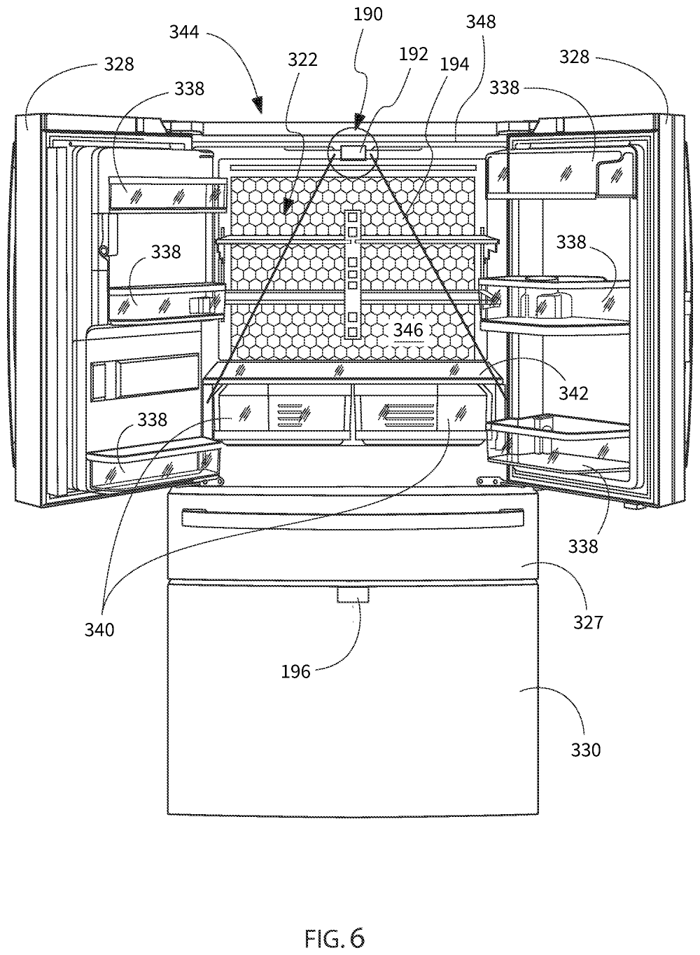

FIG. 4 is a front view of an exemplary embodiment of a refrigerator appliance 300. FIG. 5 is a perspective view of the refrigerator appliance 300. FIG. 6 is a front view of the refrigerator appliance 300 with fresh food doors 328 thereof in an open position. Refrigerator appliance 300 extends between a top 301 and a bottom 302 along a vertical direction V. Refrigerator appliance 300 also extends between a first side 305 and a second side 306 along a lateral direction L. As shown in FIG. 5, a transverse direction T may additionally be defined perpendicular to the vertical and lateral directions V and L. Refrigerator appliance 300 extends along the transverse direction T between a front portion 308 and a back portion 310.

Directional terms such as “left” and “right” are used herein with reference to the perspective of a user standing in front of the refrigerator appliance 300 to access the refrigerator and/or items stored therein. Terms such as “inner” and “outer” refer to relative directions with respect to the interior and exterior of the refrigerator appliance, and in particular the food storage chamber(s) defined therein. For example, “inner” or “inward” refers to the direction towards the interior of the refrigerator appliance. Terms such as “left,” “right,” “front,” “back,” “top,” or “bottom” are used with reference to the perspective of a user accessing the refrigerator appliance. For example, a user stands in front of the refrigerator to open the doors and reaches into the food storage chamber(s) to access items therein.

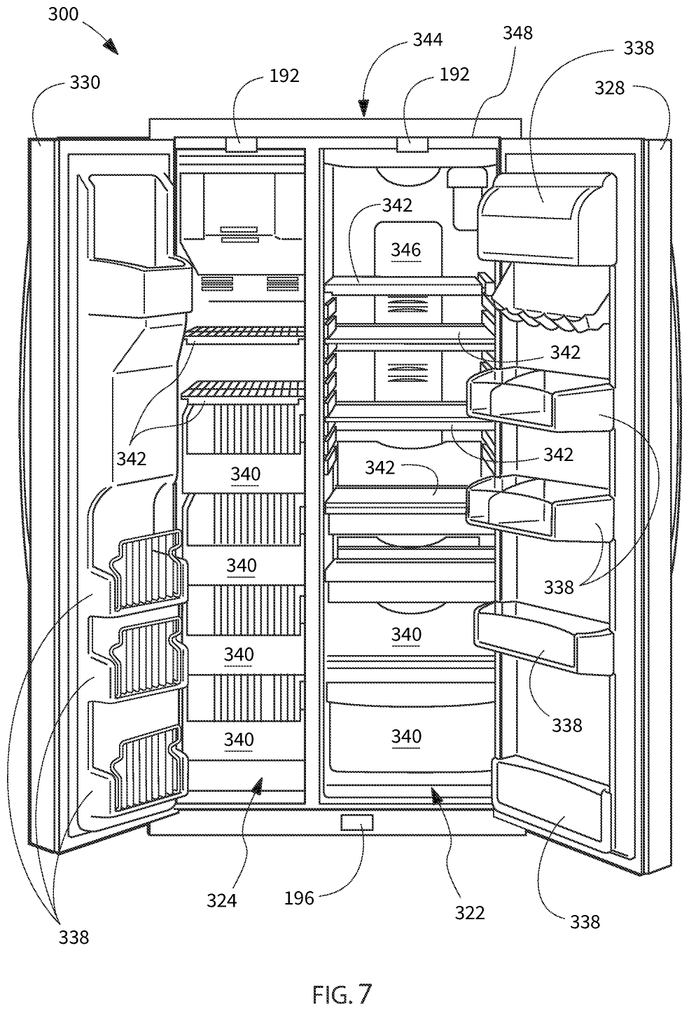

Refrigerator appliance 300 includes a cabinet or housing 320 defining an upper fresh food chamber 322 (FIG. 6) and a lower freezer chamber or frozen food storage chamber 324 arranged below the fresh food chamber 322 along the vertical direction V. As may be seen in FIGS. 6 and 7, a plurality of food storage elements, such as bins 338, shelves 342, and drawers 340 are disposed within the fresh food chamber 322. In some embodiments, an auxiliary food storage chamber (not shown) may be positioned between the fresh food chamber 322 and the freezer chamber 324, e.g., along the vertical direction V. Because the freezer chamber 324 is positioned below the fresh food chamber 322, refrigerator appliance 300 is generally referred to as a bottom mount refrigerator. In the exemplary embodiment, housing 320 also defines a mechanical compartment (not shown) for receipt of a sealed cooling system (not shown). Using the teachings disclosed herein, one of skill in the art will understand that the present invention can be used with other types of refrigerators (e.g., side-by-sides, such as the exemplary side-by-side configuration illustrated in FIG. 7) as well. Consequently, the description set forth herein is for illustrative purposes only and is not intended to limit the invention in any aspect.

Refrigerator doors 328 are each rotatably hinged to an edge of housing 320 for accessing fresh food chamber 322. As may be seen in FIGS. 6 and 7, the fresh food chamber 322 extends along the transverse direction T between a front portion 344 and a back portion 346. The front portion 344 of the fresh food chamber 322 defines an opening 348 for receipt of food items. Refrigerator doors 328 are rotatably mounted, e.g., hinged, to an edge of housing 320 for selectively accessing fresh food chamber 322. Refrigerator doors 328 may be mounted to the housing 320 at or near the front portion 344 of the fresh food chamber 322 such that the doors 328 rotate between a closed position (FIGS. 4 and 5) where the doors 328 cooperatively sealingly enclose the fresh food chamber 322 and an open position (FIGS. 6 and 7) to permit access to the fresh food chamber 322. It should be noted that while two doors 328 in a “French door” configuration are illustrated in FIG. 6, any suitable arrangement of doors utilizing one, two or more doors is within the scope and spirit of the present disclosure, such as a single door 328 at the fresh food chamber 322 as illustrated in FIG. 7. A freezer door 330 for accessing freezer chamber 324 is arranged below refrigerator doors 328 in some embodiments, e.g., as illustrated in FIG. 6, or beside refrigerator door 328 in some embodiments, e.g., as illustrated in FIG. 7, or may also be located in other arrangements, e.g., above refrigerator door(s) 328. In the exemplary embodiment illustrated in FIG. 6, freezer door 330 is coupled to a freezer drawer (not shown) slidably mounted within freezer chamber 324, while the exemplary freezer door 330 in the embodiment illustrated in FIG. 7 is rotatably coupled to the cabinet 320. An auxiliary door 327 may be coupled to an auxiliary drawer (not shown) which is slidably mounted within the auxiliary chamber (not shown).

Operation of the refrigerator appliance 300 can be regulated by a controller 334 that is operatively coupled to a user interface panel 336. User interface panel 336 provides selections for user manipulation of the operation of refrigerator appliance 300 to modify environmental conditions therein, such as temperature selections, etc. In some embodiments, user interface panel 336 may be proximate a dispenser assembly 332. Panel 336 provides selections for user manipulation of the operation of refrigerator appliance 300 such as, e.g., temperature selections, selection of automatic or manual override humidity control (as described in more detail below), etc. In response to user manipulation of the user interface panel 336, the controller 334 operates various components of the refrigerator appliance 300. Operation of the refrigerator appliance 300 can be regulated by the controller 334, e.g., controller 334 may regulate operation of various components of the refrigerator appliance 300 in response to programming and/or user manipulation of the user interface panel 336.

The controller 334 may include a memory and one or more microprocessors, CPUs or the like, such as general or special purpose microprocessors operable to execute programming instructions or micro-control code associated with operation of refrigerator appliance 300. The memory may represent random access memory such as DRAM, or read only memory such as ROM or FLASH. In one embodiment, the processor executes programming instructions stored in memory. The memory may be a separate component from the processor or may be included onboard within the processor. It should be noted that controllers 334 as disclosed herein are capable of and may be operable to perform any methods and associated method steps as disclosed herein.

The controller 334 may be positioned in a variety of locations throughout refrigerator appliance 300. In the illustrated embodiment, the controller 334 may be located within the door 328. In such an embodiment, input/output (“I/O”) signals may be routed between the controller and various operational components of refrigerator appliance 300. In one embodiment, the user interface panel 336 may represent a general purpose I/O (“GPIO”) device or functional block. In one embodiment, the user interface panel 336 may include input components, such as one or more of a variety of electrical, mechanical or electro-mechanical input devices including rotary dials, push buttons, and touch pads. The user interface panel 336 may include a display component, such as a digital or analog display device designed to provide operational feedback to a user. For example, the user interface panel 336 may include a touchscreen providing both input and display functionality. The user interface panel 336 may be in communication with the controller via one or more signal lines or shared communication busses.

Using the teachings disclosed herein, one of skill in the art will understand that the present subject matter can be used with other types of refrigerators such as a refrigerator/freezer combination, side-by-side, bottom mount, compact, and any other style or model of refrigerator appliance. Accordingly, other configurations of refrigerator appliance 300 could be provided, it being understood that the configurations shown in the accompanying FIGS. and the description set forth herein are by way of example for illustrative purposes only.

As will be described in more detail below, refrigerator appliance 300 may further include features that are generally configured to detect the presence and, in some embodiments, identity of a user. More specifically, such features may include one or more sensors, e.g., cameras 192 and/or 196 (see, e.g., FIGS. 6 and 7), or other detection devices that are used to monitor the refrigerator appliance 300 and an area in front of the cabinet 320 that is contiguous with a food storage chamber, e.g., the food chamber 322 and/or freezer chamber 324, such as an area in which a user accessing the food storage chamber is likely to be present. The sensors or other detection devices may be operable to detect and monitor presence of one or more users that are accessing the refrigerator appliance 300, and in particular the fresh food chamber 322 and/or freezer chamber 324 thereof. In this regard, the refrigerator appliance 300 may use data from each of these devices to obtain a representation or knowledge of the identity, position, and/or other qualitative or quantitative characteristics of one or more users.

As will be described in more detail below, household appliance 10 may further include features that are generally configured to detect the presence and identity of a user. More specifically, such features may include one or more sensors, e.g., cameras 192 (see, e.g., FIGS. 1, 6, and 7), or other detection devices that are used to monitor the household appliance 10 and an area in front of the cabinet 12, such as an area in which a user accessing the household appliance 10 is likely to be present. The sensors or other detection devices may be operable to detect and monitor presence of one or more users that are accessing the household appliance 10. In this regard, the household appliance 10 may use data from each of these devices to obtain a representation or knowledge of the identity, position, and/or other qualitative or quantitative characteristics of one or more users.

As shown schematically in FIGS. 1, 6, and 7, the user detection system may include a camera assembly 190 that is generally positioned and configured for obtaining images of the household appliance 10 and adjoining areas, e.g., in front of the household appliance 10, during operation of the camera assembly 190. In some exemplary embodiments, e.g., as illustrated in FIGS. 1, 6, and 7, camera assembly 190 includes one or more cameras 192. The one or more cameras 192 may be mounted to cabinet 12 or otherwise positioned in view of an area in front of the cabinet 12. As shown in FIGS. 1, 6, and 7, a camera 192 of camera assembly 190 is mounted to a front side of the cabinet of the household appliance 10, e.g., at user interface panel 100 at the front side 22 of cabinet 12 in the example embodiment illustrated in FIG. 1, and is forward-facing, e.g., is oriented to have a field of vision or field of view directed towards an area in front of the cabinet 12, such as directly and immediately in front of the cabinet 12.

Although a single camera 192 is illustrated in FIG. 1, it should be appreciated that camera assembly 190 may include a plurality of cameras 192, wherein each of the plurality of cameras 192 has a specified monitoring zone or range positioned in and/or around household appliance 10, such as multiple cameras oriented in or facing various directions, and/or a second forward-facing camera. In this regard, for example, the field of view of each camera 192 may be limited to or focused on a specific area. For example, according to the illustrated embodiments in FIGS. 6 and 7, camera assembly 190 includes one or more first cameras 192 and one or more second cameras 196. First camera 192 and second camera 196 may be configured and operable to receive and record varying types of images. For example, the first camera 192 (FIG. 6) or first cameras 192 (FIG. 7) may be a photo camera or cameras, operable to receive and record or capture images based on light having wavelength(s) within the visible light spectrum, while the second camera 196 may be an infrared (IR) camera, e.g., may be operable to receive and record or capture images based on infrared light. The one or more cameras 192, 196 may be mounted to cabinet 320, to doors 328, or otherwise positioned in view of fresh food chamber 322, and/or an area in front of the cabinet 320 that is contiguous with the fresh food chamber 322. As shown in FIG. 6, a camera 192 of camera assembly 190 is mounted to cabinet 320 at the front opening 348 of fresh food chamber 322 and is oriented to have a field of view 194 directed across the front opening and/or into fresh food chamber 322 and in front of the fresh food chamber 322. As shown in FIG. 7, each camera 192 (of the two cameras 192 in this embodiment) is mounted to cabinet 320 at a respective front opening of fresh food chamber 322 and freezer chamber 324, such that each camera 192 is oriented to have a field of view 194 directed across the front opening and/or into each respective food storage chamber and in front of the fresh food chamber 322 and freezer chamber 324.

In some embodiments, it may be desirable to activate the photo camera or cameras 192 for limited time durations and only in response to certain triggers. For example, the IR camera, e.g., second camera 196, may be always on and may serve as a proximity sensor, such that the photo camera(s) 192 are only activated after the IR camera 196 detects motion at the front of the household appliance 10. In additional embodiments, the activation of the first camera(s) 192 may be in response to an interaction with the household appliance, such as a door opening, such as detecting that a door of the household appliance 10, such as the door 134 of the washing machine appliance, the door of the dryer appliance, or one of the doors, e.g., door 328 of the refrigerator appliance 300 was opened using a door switch, or an interaction with the user interface, such as pressing a button or touching a touchscreen control, etc. In this manner, privacy concerns related to obtaining images of the user of the household appliance 10 may be mitigated. According to exemplary embodiments, camera assembly 190 may be used to facilitate a user detection and/or identification process for household appliance 10. As such, each camera 192 may be positioned at the front opening 348 to fresh food chamber 322 to monitor one or more doors 328 and/or 330 and adjoining areas, such as while food items are being added to or removed from fresh food chamber 322 and/or freezer chamber 324 or laundry articles are being added to or removed from wash chamber 126 or chamber 25 of the dryer appliance 11, etc. In this manner, privacy concerns related to obtaining images of the user of the household appliance 10 may be mitigated. According to exemplary embodiments, camera assembly 190 may be used to facilitate a user detection and/or recognition process for the household appliance 10. As such, each camera 192 may be positioned and oriented to monitor one or more areas of the household appliance 10 and adjoining areas, such as while a user is accessing or attempting to access the household appliance 10.

It should be appreciated that according to alternative embodiments, camera assembly 190 may include any suitable number, type, size, and configuration of camera(s) 192 for obtaining images of any suitable areas or regions within or around household appliance 10. In addition, it should be appreciated that each camera 192 may include features for adjusting the field of view and/or orientation.

It should be appreciated that the images obtained by camera assembly 190 may vary in number, frequency, angle, resolution, detail, etc. in order to improve the clarity of the particular regions surrounding or within household appliance 10. In addition, according to exemplary embodiments, controller 210 may be configured for illuminating the household appliance 10 and/or surrounding areas using one or more light sources prior to obtaining images. Notably, controller 210 or 334 of household appliance 10 (or any other suitable dedicated controller) may be communicatively coupled to camera assembly 190 and may be programmed or configured for analyzing the images obtained by camera assembly 190, e.g., in order to detect and/or identify a user proximate to the household appliance 10, as described in more detail below.

In general, controller 210 or 334 may be operably coupled to camera assembly 190 for analyzing one or more images obtained by camera assembly 190 to extract useful information regarding objects or people within the field of view of the one or more cameras 192. In this regard, for example, images obtained by camera assembly 190 may be used to extract a facial image or other identifying information related to one or more users. Notably, this analysis may be performed locally (e.g., on controller 210 or 334) or may be transmitted to a remote server (e.g., in the “cloud,” as those of ordinary skill in the art will recognize as referring to a remote server or database in a distributed computing environment including at least one remote computing device) for analysis. Such analysis is intended to facilitate user detection, e.g., by identifying a user accessing the household appliance, such as a user who may be operating, e.g., activating or adjusting, one or more components of the household appliance 10 or otherwise accessing the household appliance 10.

Specifically, according to an exemplary embodiment as illustrated in FIG. 1, camera 192 (or multiple cameras 192 in the camera assembly 190 collectively) may be oriented away from a center of cabinet 12 and define a field of view that covers an area in front of cabinet 12. In this manner, the field of view of camera 192, and the resulting images obtained, may capture any motion or movement of a user accessing or operating the household appliance. The images obtained by camera assembly 190 may include one or more still images, one or more video clips, or any other suitable type and number of images suitable for detection and/or identification of a user.

Notably, camera assembly 190 may obtain images upon any suitable trigger, such as a time-based imaging schedule where camera assembly 190 periodically images and monitors the field of view, e.g., in and/or in front of the household appliance 10. According to still other embodiments, camera assembly 190 may periodically take low-resolution images until motion (such as approaching the household appliance 10, opening a door thereof, or reaching for one of the controls or user inputs thereof) is detected (e.g., via image differentiation of low-resolution images), at which time one or more high-resolution images may be obtained. According to still other embodiments, household appliance 10 may include one or more motion sensors (e.g., optical, acoustic, electromagnetic, etc.) that are triggered when an object or user moves into or through the area in front of the household appliance 10, and camera assembly 190 may be operably coupled to such motion sensors to obtain images of the object during such movement. In some embodiments, the camera assembly 190 may only obtain images when the household appliance is activated, as will be understood by those of ordinary skill in the art. Thus, for example, when the household appliance 10 is operating, the camera assembly 190 may then continuously or periodically obtain images, or may apply the time-based imaging schedule, motion detection based imaging, or other imaging routines/schedules throughout the time that the household appliance 10 is operating.

It should be appreciated that the images obtained by camera assembly 190 may vary in number, frequency, angle, resolution, detail, etc. in order to improve the clarity thereof. In addition, according to exemplary embodiments, controller 210 may be configured for illuminating a light (not shown) while obtaining the image or images. Other suitable imaging triggers are possible and within the scope of the present subject matter.

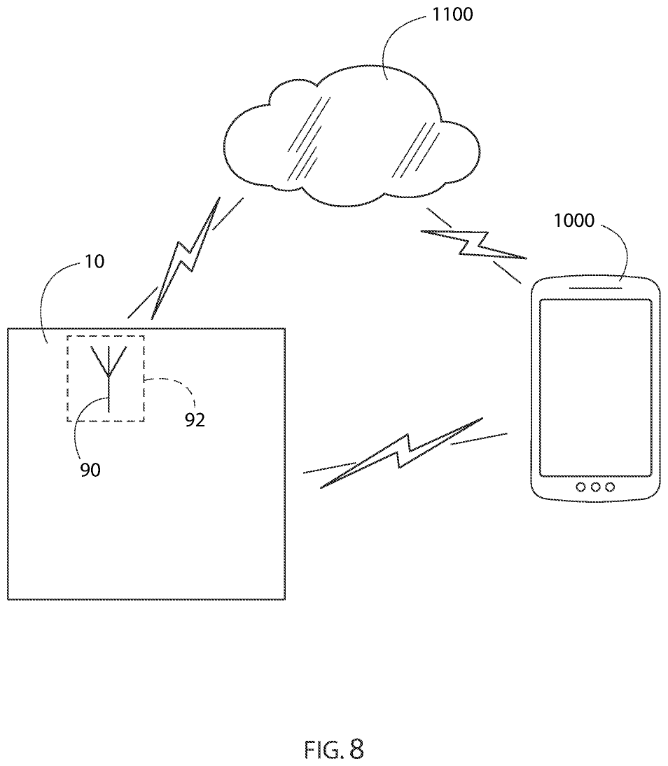

Turning now to FIG. 8, a general schematic is provided of a household appliance 10, which may be any of the exemplary household appliances mentioned herein, such as a laundry appliance or refrigerator appliance or other suitable household appliance, and which communicates wirelessly with a remote user interface device 1000 and a network 1100. For example, as illustrated in FIG. 8, the household appliance 10 may include an antenna 90 by which the household appliance 10 communicates with, e.g., sends and receives signals to and from, the remote user interface device 1000 and/or network 1100. The antenna 90 may be part of, e.g., onboard, a communications module 92. The communications module 92 may be a wireless communications module operable to connect wirelessly, e.g., over the air, to one or more other devices via any suitable wireless communication protocol. For example, the communications module 92 may be a WI-FI® module, a BLUETOOTH® module, or a combination module providing both WI-FI® and BLUETOOTH® connectivity. The remote user interface device 1000 may be a laptop computer, smartphone, tablet, personal computer, wearable device, smart speaker, smart home system, and/or various other suitable devices. The communications module 92 may be onboard the controller 210 or 334 or may be a separate module.

The household appliance 10 may be in communication with the remote user interface device 1000 device through various possible communication connections and interfaces. The household appliance 10 and the remote user interface device 1000 may be matched in wireless communication, e.g., connected to the same wireless network. The household appliance 10 may communicate with the remote user interface device 1000 via short-range radio such as BLUETOOTH® or any other suitable wireless network having a layer protocol architecture. As used herein, “short-range” may include ranges less than about ten meters and up to about one hundred meters. For example, the wireless network may be adapted for short-wavelength ultra-high frequency (UHF) communications in a band between 2.4 GHz and 2.485 GHz (e.g., according to the IEEE 802.15.1 standard). In particular, BLUETOOTH® Low Energy, e.g., BLUETOOTH® Version 4.0 or higher, may advantageously provide short-range wireless communication between the household appliance 10 and the remote user interface device 1000. For example, BLUETOOTH® Low Energy may advantageously minimize the power consumed by the exemplary methods and devices described herein due to the low power networking protocol of BLUETOOTH® Low Energy.

The remote user interface device 1000 is “remote” at least in that it is spaced apart from and not physically connected to the household appliance 10, e.g., the remote user interface device 1000 is a separate, stand-alone device from the household appliance 10 which communicates with the household appliance 10 wirelessly. Any suitable device separate from the household appliance 10 that is configured to provide and/or receive communications, information, data, or commands from a user may serve as the remote user interface device 1000, such as a smartphone (e.g., as illustrated in FIG. 8), smart watch, personal computer, smart home system, or other similar device. For example, the remote user interface device 1000 may be a smartphone operable to store and run applications, also known as “apps,” and some or all of the method steps disclosed herein may be performed by a smartphone app.

The remote user interface device 1000 may include a memory for storing and retrieving programming instructions. Thus, the remote user interface device 1000 may provide a remote user interface which may be an additional user interface to the user interface panel 100 or 336. For example, the remote user interface device 1000 may be a smartphone operable to store and run applications, also known as “apps,” and the additional user interface may be provided as a smartphone app.

As mentioned above, the household appliance 10 may also be configured to communicate wirelessly with a network 1100. The network 1100 may be, e.g., a cloud-based data storage system including one or more remote computing devices such as remote databases and/or remote servers, which may be collectively referred to as “the cloud.” For example, the household appliance 10 may communicate with the cloud 1100 over the Internet, which the household appliance 10 may access via WI-FI®, such as from a WI-FI® access point in a user's home.

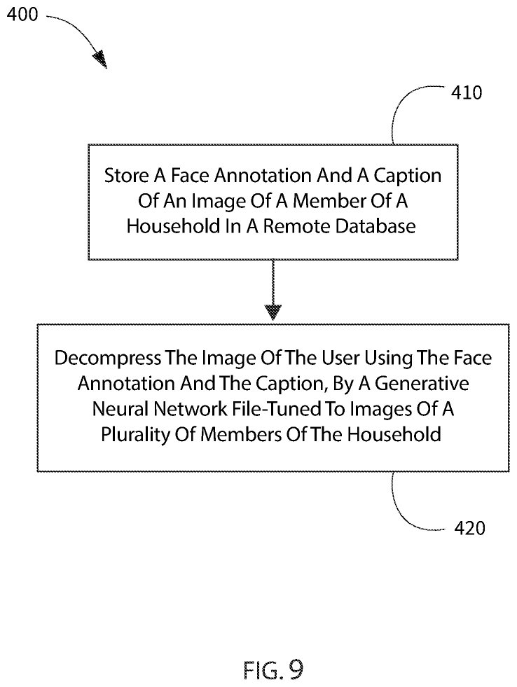

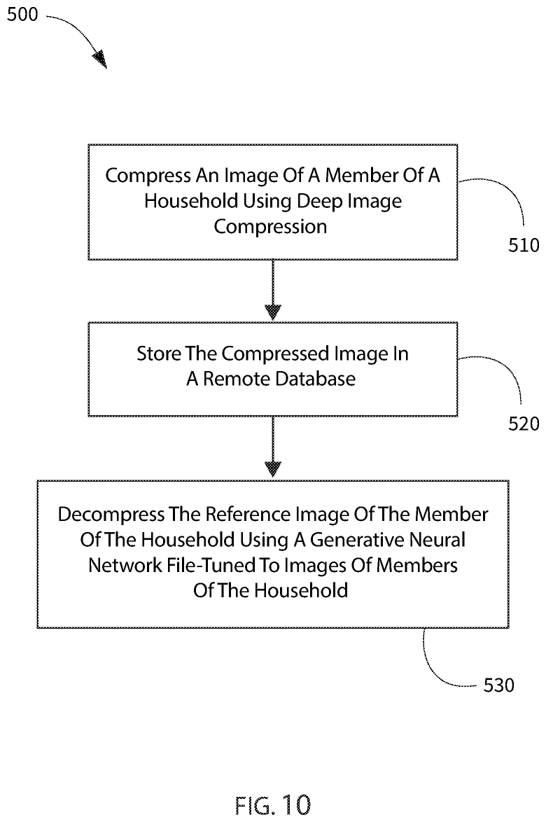

Embodiments of the present disclosure may include methods such as methods 400 (FIG. 9) and 500 (FIG. 10) of r handling an image of a member of a household. For example, the household may include a plurality of members, such as members of a family, roommates, coworkers, or other groups of people who cohabitate or otherwise share a common space, such as may include one or more household appliances, such as the exemplary household appliance 10 described above, within the common space.

An exemplary method 400 of recognizing a handling an image of a member of a household is illustrated in FIG. 9. As shown in FIG. 9, method 400 may include, at step 410, storing a face annotation of the image of the member of the household in a remote database and storing a caption of the image of the member of the household in the remote database. Method 400 may also include a step 420 of decompressing the image of the member of the household using the face annotation and the caption. The decompression may be performed using a generative neural network, such as a generative adversarial neural network. The term “neural network” is used herein to refer to computing systems and algorithms which are inspired by biological neural networks, as is generally understood in the image processing art.

For example, decompressing the reference image may be performed using a generative neural network that is file-tuned to images of members of the household. The generative neural network may be trained on a library or album of images specific to the household, such as a user's (e.g., a user of a household appliance which is included in the household) photographs and images, e.g., rather than training the generative neural network on a generic or generalized library of images, thus, the generative neural network may be file-tuned to images of members of the household in that the generative neural network may be trained on a specific library of images of the members of the household, and, as mentioned, in some embodiments the household may include one or more household appliances. Such limited and specific training of the generative neural network may provide numerous advantages. For example, such file-tuning is a low computational intensity task as compared to fully training a model.

Another exemplary method 500 of handling an image of a member of a household is illustrated in FIG. 10. As shown in FIG. 10, method 500 may include, at step 510, compressing a reference image of the user. The compression may be performed using deep image compression. Deep image compression generally includes multiple levels of image compression. For example, deep image compression may include the implementation of a deep neural network (“DNN”) image compression process, which generally includes the use of a neural network with multiple layers between input and output. Other suitable image handling processes, neural network processes, artificial intelligence analysis techniques, and combinations of the above described methods or other known methods may be used while remaining within the scope of the present subject matter.

Method 500 may also include a step 520 of storing the compressed reference image in a remote database, e.g., in the cloud, the fog, the edge, or other distributed computing environment and/or in any suitable database which may connect to and communication via the internet or other suitable remote communication network. Method 500 may further include a step 530 of decompressing the reference image of the user. For example, the reference image of the user may be decompressed using a generative neural network, such as a generative neural network that is file-tuned to images of members of the household, as described above with reference to method 400.

Method 500 may, in some embodiments, further include storing a face annotation and a caption of the reference image of the user in the remote database. In such embodiments, decompressing the reference image of the user may include decompressing the reference image of the user from the face annotation and the caption.

Referring now generally to FIGS. 9 and 10, the methods 400 and/or 500 may be interrelated and/or may have one or more steps from one of the methods 400 and 500 combined with the other method 400 or 500. Thus, those of ordinary skill in the art will recognize that the various steps of the exemplary methods described herein may be combined in various ways to arrive at additional embodiments within the scope of the present disclosure.

In some embodiments, methods according to the present disclosure, such as exemplary methods 400 and/or 500, may include steps for, and/or the household appliance may be configured for, recognizing one or more users, e.g., based on one or more images. In some embodiments, a household appliance may include a camera assembly operable to obtain an image, such as but not limited to the camera assembly 190 illustrated in FIGS. 1, 6, and 7 and described above. In such embodiments, detection of the user(s) may be accomplished with the camera assembly 190. For example, the household appliance may include a camera, and exemplary methods may include, and/or the household appliance may be configured for, capturing or obtaining an image with the camera and detecting the user(s) based on the image obtained by the camera. The structure and operation of cameras are understood by those of ordinary skill in the art and, as such, the camera is not illustrated or described in further detail herein for the sake of brevity and clarity. In such embodiments, the controller 210 or 334 of the household appliance 10 may be configured for image-based processing, e.g., to detect a user and recognize the user, e.g., determine an identity of the user based on the obtained image of the user, e.g., a photograph taken with the camera(s) 192 of the camera assembly 190. For example, the controller 210 or 334 may be configured to identify the user by comparison of the image to a stored image of a known or previously-identified user. For example, controller 210 or 334 of household appliance 10 (or any other suitable dedicated controller) may be communicatively coupled to camera assembly 190 and may be programmed or configured for analyzing the images obtained by camera assembly 190, e.g., in order to detect a user accessing or proximate to household appliance 10 and to identify the user.

Such analysis may include comparing the image or images obtained by camera assembly 190 with one or more reference images with known users represented or captured in the reference image(s). For example, the reference image(s) may be stored remotely, such as in a remote database, e.g., in a distributed computing environment such as the cloud, the fog, or the edge. The reference image(s) may be retrieved by the household appliance for comparison, or the image or images obtained by camera assembly 190 may be transmitted to a remote computing device (e.g., over the internet and/or in a distributed computing environment) such that the comparison may be performed remotely. The reference image(s) may be compressed for storage, e.g., to reduce the file size of the reference image or of each reference image, and may be decompressed for analysis, e.g., comparison with the image or images obtained by camera assembly 190. The image compression and/or decompression according to the present disclosure may advantageously provide increased data compression ratios and may also provide improved fidelity after decompression, such as of certain areas of interest within the reference image(s), such as faces of known users, e.g., members of the household in which the household appliance is located and used.

In some embodiments, exemplary methods such as method 400 and/or method 500 may also include a obtaining an image of the user at the household appliance. For example, the household appliance may include a camera assembly and the image may be obtained using the camera assembly.

In such embodiments, an exemplary method may also include comparing the decompressed reference image with the obtained image. Such comparison may be performed using any suitable image analysis process. For example, the comparison may be pixel-by-pixel across the entire image or across a designated portion of the image, such as a facial region or facial regions. Such comparison may also include masking portions of one or both of the reference image and the obtained image, whereby selected portions of one or both of the reference image and the obtained image may be used in the comparison.

Such exemplary methods may further include recognizing the user based on the comparison of the decompressed reference image with the obtained image. For example, the comparison may include determining a similarity score (which may also be referred to as a confidence score) of the reference image and the obtained image, and the user may be recognized based on the similarity score at or above a predetermined threshold score.

Furthermore, the skilled artisan will recognize the interchangeability of various features from different embodiments. Similarly, the various method steps and features described, as well as other known equivalents for each such methods and feature, can be mixed and matched by one of ordinary skill in this art to construct additional systems and techniques in accordance with principles of this disclosure. Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

In some embodiments, methods according to the present disclosure, such as exemplary methods 400 or 500, may include recognizing, by a computer-implemented facial recognition algorithm, common faces in a plurality of images. For example, the common faces may be faces of members of a household comprising the household appliance. Also by way of example, the plurality of images are a user-defined library of images, such as a library of family or household photos, or a collection of photos tagged by a user as containing household members, etc. Such embodiments may also include generating, by the computer-implemented facial recognition algorithm, a face annotation for each recognized face in the plurality of images. In such embodiments, the face annotation of the reference image of the user stored in the remote database may be one of the face annotations of the recognized common faces in the plurality of images. Such embodiments may also include generating a caption for each image of the plurality of images by a separate artificial intelligence model, and the caption of the reference image of the user stored in the remote database may be one of the captions generated by the separate artificial intelligence model.

For example, methods according to the present disclosure may include using an image-to-text algorithm including an encoder neural network and a decoder neural network to generate the image captions, and a separate model, e.g., a CNN or R-CNN model, to generate the face annotation. Thus, the image caption and the face annotation may be generated by separate artificial intelligence models.

In some embodiments, the face annotation may include an identifier of the user and coordinates of a region of the reference image. The region of the reference image may include an image of the user's face. In such embodiments, decompressing the reference image of the user from the face annotation and the caption may include inputting the caption into a generative neural network and decompressing the region of the reference image using the generative neural network.

Exemplary methods according to the present disclosure, such as method 400 or method 500, may also include loss calculation and may only compress images with low loss metrics. For example, in some embodiments, exemplary methods may include calculating loss metrics of the reference image prior to compressing the reference image. In such embodiments, the calculated loss metrics may include average loss in the reference image as a whole and local loss in the region of the reference image including the image of the user's face. Thus, such exemplary methods may further include determining that one or both of the calculated loss metrics is below a loss threshold prior to compressing the image.

In one or more additional exemplary embodiments, methods according to the present disclosure, such as image compression steps of such methods, may also include using the deep image compression to reduce the file size of the reference image, followed by encoding the reference image. In such embodiments, decompressing the reference image of the user using the generative neural network may include decoding the reference image, applying a caption to the decoded reference image, and inputting the caption and the decoded reference image into the generative neural network.

As discussed above, the exemplary methods 400 and 500 include handling, e.g., compressing and/or decompressing, one or more images. It should be appreciated that this image handling may utilize any suitable image analysis techniques, image decomposition, image segmentation, image processing, etc. This handling may be performed entirely by controller 210 or 334, may be offloaded to a remote server (e.g., in the cloud 1100) for processing or analysis, may be handled with user assistance (e.g., via user interface panel 100), or may be handled in any other suitable manner. According to exemplary embodiments of the present subject matter, the image handling may include a machine learning image recognition process.

According to exemplary embodiments, this image handling may use any suitable image processing technique, image recognition process, etc. As used herein, the terms “image handling” and the like may be used generally to refer to any suitable method of observation, analysis, image compression or decompression, image decomposition, feature extraction, image classification, etc. of one or more images, videos, or other visual representations of an object. As explained in more detail below, this image handling may include the implementation of image processing techniques, image recognition techniques, or any suitable combination thereof. In this regard, the image handling may use any suitable image handling software or algorithm. It should be appreciated that this image handling or processing may be performed locally (e.g., by controller 210 or 334) or remotely (e.g., by offloading image data to a remote server or network, e.g., in the cloud).

Specifically, the handling of the one or more images may include implementation of an image processing algorithm. As used in this paragraph and the following paragraph, the terms “image processing” and the like are generally intended to refer to any suitable methods or algorithms for analyzing images that do not rely on artificial intelligence or machine learning techniques (e.g., in contrast to the machine learning image handling processes described below). For example, the image processing algorithm may rely on image differentiation, e.g., such as a pixel-by-pixel comparison of two sequential images. This comparison may help identify substantial differences between the sequentially obtained images, e.g., to identify movement, the presence of a particular object or user, the existence of a certain condition, etc. For example, one or more reference images may be obtained when a particular condition exists, and these references images may be stored for future comparison with images obtained during appliance operation. In a particular example, the reference images may be or include images of the face or faces of one or more users, e.g., household members as described above, such that the extant particular condition in the reference images is the presence of a known user. Similarities and/or differences between the reference image and the obtained image may be used to extract useful information for improving appliance performance. For example, image differentiation may be used to determine when a pixel level motion metric passes a predetermined motion threshold.

The processing algorithm may further include measures for isolating or eliminating noise in the image comparison, e.g., due to image resolution, data transmission errors, inconsistent lighting, or other imaging errors. By eliminating such noise, the image processing algorithms may improve accurate object detection, avoid erroneous object detection, and isolate the important object, region, or pattern within an image (the term “object” is used broadly herein to include humans, e.g., users of the household appliance). In addition, or alternatively, the image processing algorithms may use other suitable techniques for recognizing or identifying particular items or objects, such as edge matching, divide-and-conquer searching, greyscale matching, histograms of receptive field responses, or another suitable routine (e.g., executed at the controller 210 or 334 based on one or more captured images from one or more cameras). Other image processing techniques are possible and within the scope of the present subject matter.

In addition to the image processing techniques described above, the image handling, e.g., compression or decompression, may include utilizing artificial intelligence (“AI”), such as a machine learning image handling process, a neural network classification module, any other suitable artificial intelligence (AI) technique, and/or any other suitable image handling techniques, examples of which will be described in more detail below. Moreover, each of the exemplary image analysis or evaluation processes described below may be used independently, collectively, or interchangeably to optimize the compression rate, loss metrics, or other factors of the image handling to facilitate performance of one or more methods described herein or to otherwise improve appliance operation. According to exemplary embodiments, any suitable number and combination of image processing, image recognition, or other image analysis techniques may be used to obtain an accurate, high compression rate and minimal loss, image handling technique.

In this regard, the image handling process may use any suitable artificial intelligence technique, for example, any suitable machine learning technique, or for example, any suitable deep learning technique. According to an exemplary embodiment, the image handling process may include the implementation of a form of image recognition called region based convolutional neural network (“R-CNN”) image recognition. Generally speaking, R-CNN may include taking an input image and extracting region proposals that include a potential object or region of an image. In this regard, a “region proposal” may be one or more regions in an image that could belong to a particular object (e.g., a human or animal face, such as the face of a known user or household member) or may include adjacent regions that share common pixel characteristics. A convolutional neural network is then used to compute features from the region proposals and the extracted features will then be used to determine a classification for each particular region.

According to still other embodiments, an image segmentation process may be used along with the R-CNN image recognition. In general, image segmentation creates a pixel-based mask for each object in an image and provides a more detailed or granular understanding of the various objects within a given image. In this regard, instead of processing an entire image—i.e., a large collection of pixels, many of which might not contain useful information-image segmentation may involve dividing an image into segments (e.g., into groups of pixels containing similar attributes) that may be analyzed independently or in parallel to obtain a more detailed representation of the object or objects in an image. This may be referred to herein as “mask R-CNN” and the like, as opposed to a regular R-CNN architecture. For example, mask R-CNN may be based on fast R-CNN which is slightly different than R-CNN. For example, R-CNN first applies a convolutional neural network (“CNN”) and then allocates it to zone recommendations on the covn5 property map instead of the initially split into zone recommendations. In addition, according to exemplary embodiments, standard CNN may be used to obtain, identify, or detect any other qualitative or quantitative data related to one or more objects or regions within the one or more images. In addition, a K-means algorithm may be used.

According to still other embodiments, the image handling (where image “handling” includes compression and/or decompression, as noted above) process may use any other suitable neural network process while remaining within the scope of the present subject matter. For example, the steps of detecting and identifying a user may include analyzing the one or more images using a deep belief network (“DBN”) image recognition process. A DBN image recognition process may generally include stacking many individual unsupervised networks that use each network's hidden layer as the input for the next layer. According to still other embodiments, the handling or analyzing of one or more images may include the implementation of a deep neural network (“DNN”) image recognition process, which generally includes the use of a neural network with multiple layers between input and output. Other suitable image compression, decompression, or recognition processes, neural network processes, artificial intelligence analysis techniques, and combinations of the above described methods or other known methods may be used while remaining within the scope of the present subject matter.

For example, image handling according to the present disclosure may include one or more facial recognition algorithms. Such facial recognition algorithms may include identifying and measuring facial features, e.g., eye spacing, nose bridge width, mouth (lip) height and width, and measuring the absolute or relative sizes and positions of such features within an individual face, such as the distance between any two or more facial features, e.g., distance between nose and mouth or distance from forehead to chin, etc. The facial recognition algorithm may also convert the face data into a numerical value or string, sometimes referred to as a faceprint. Such information may also be useful in image decompression, e.g., digitally reconstructing the user's face from a low-resolution (compressed) image file.

Image captioning, e.g., generating a description of the content of the image in words, may also promote accuracy and speed of decompressing image files. For example, each image may be annotated with a caption, and the caption may then be used to assist in decompressing the image. The captions may be generated using a system or algorithm which produces a textual description of the image. Such captioning process may include natural language processing and computer vision functions. For example, a plurality of neural networks may be used sequentially to generate captions from an input image, such as in an encoder-decoder framework. In one such example, the image may first be input into a Convolutional Neural Network (“CNN”) encoder which extracts the features depicted in the image, and, in some embodiments, the encoder may be tuned to extract only facial information, e.g., to reduce computational requirements. The last hidden layer of the CNN encoder may be connected to a Recurrent Neural Network (“RNN”) decoder, whereby the output of the CNN encoder is input to the RNN, and the RNN, in turn, then generates captions corresponding to the extracted features in the form of text such as natural language text.

The compression and/or decompression portions of the image handling may be performed by or using a pretrained generative algorithm, such as a Generative Adversarial Network (“GAN”). As mentioned above, the GAN may begin with a generalized super-resolution algorithm that is then trained specifically on the user's images, such as specifically on images including faces of members of the household in which the household appliance is located and used, e.g., the GAN may be file-tuned on the user's images as mentioned above. The GAN may generally be configured to generate super-resolution images from the low-resolution (compressed) images, e.g., based on or with reference to the image caption. In addition to the image caption, a face annotation may be input into the GAN to aid in decompressing the image. The face annotation may include coordinates, such as simple X-Y coordinates, which identify a region of the image including a person's face, and an identifier of the person, such as a user ID number or family ID number.

A GAN has two neural networks, a generator and a discriminator, with the output of the generator directly connected to the input of the discriminator. The generator produces plausible data, and the discriminator distinguishes real data from fake data out of the plausible data generated by the generator. The discriminator in a GAN is a classifier, e.g., which classifies the data output from the generator as real or fake, and such classification may be used by the generator, through backpropagation, to update the weights on the nodes of the generator network. Once the GAN is trained, the discriminator is less able, such as unable, to accurately classify the data generated by the generator, such as fake data from the generator may be practically indistinguishable from real data. For example, in an image decompression application, the generator network may generate plausible image data which is not included in the compressed image but which is practically indistinguishable from the original, uncompressed image. The speed and accuracy of the decompression using the GAN may be improved by providing an image caption as input into the GAN along with the compressed image.

In some embodiments, exemplary methods of image handling as disclosed herein may include deep compression, such as a multi-layer compression including both one or more AI or neural network based compression process to initially reduce the image size, followed by a lossy compression algorithm, e.g., JPEG or other similar image encoding. Decompression of such compressed images may include decoding the lossy algorithm, e.g., JPEG image, applying a caption or image annotation, and running a generative model to reach the full resolution image. For example, the decoded JPEG and the caption may be input into a GAN to fully decompress the image after such deep compression.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of handling an image of a member of a household, the household comprising a plurality of members, the method comprising:
storing a face annotation and a caption of the image of the member of the household in a remote database; and
decompressing the image of the member of the household using the face annotation and the caption, wherein decompressing the reference image is performed using a generative neural network, and wherein the generative neural network is file-tuned to images of the plurality of members of the household.

2. The method of claim 1, wherein the household comprises a household appliance, the method further comprising:
obtaining, with a camera assembly of the household appliance, an image of a user at the household appliance;
comparing the decompressed image with the obtained image; and
recognizing the user at the household appliance as the member of the household based on the comparison of the decompressed image with the obtained image.

3. The method of claim 1, further comprising recognizing, by a computer-implemented facial recognition algorithm, common faces in a plurality of images and generating, by the computer-implemented facial recognition algorithm, a face annotation for each recognized face in the plurality of images, wherein the face annotation of the image of the member of the household stored in the remote database is one of the face annotations of the recognized common faces in the plurality of images.

4. The method of claim 3, wherein the common faces are faces of the plurality of members of the household.

5. The method of claim 3, wherein the plurality of images are a user-defined library of images.

6. The method of claim 3, further comprising generating a caption for each image of the plurality of images by a separate artificial intelligence model, wherein the caption of the image of the member of the household stored in the remote database is one of the captions generated by the separate artificial intelligence model.

7. The method of claim 1, wherein the face annotation comprises an identifier of the member of the household and coordinates of a region of the image, the region of the image including an image of the face of the member of the household.

8. The method of claim 7, wherein decompressing the image of the member of the household from the face annotation and the caption comprises inputting the caption into the generative neural network and decompressing the region of the image using the generative neural network.

9. The method of claim 1, wherein the face annotation comprises coordinates of a region of the image, the region of the image including an image of the face of the member of the household, further comprising calculating loss metrics of the image, wherein the calculated loss metrics comprise average loss in image as a whole and local loss in the region of the image including the image of the face of the member of the household.

10. A method of handling an image of a member of a household, the method comprising:
compressing the image of the member of the household using deep image compression;
storing the compressed image in a remote database; and
decompressing the image of the member of the household using a generative neural network file-tuned to images of members of the household.

11. The method of claim 10, further comprising storing a face annotation and a caption of the image of the member of the household in the remote database, wherein decompressing the image of the member of the household comprises decompressing the image of the member of the household from the face annotation and the caption.

12. The method of claim 11, further comprising recognizing, by a computer-implemented facial recognition algorithm, common faces in a plurality of images and generating, by the computer-implemented facial recognition algorithm, a face annotation for each recognized face in the plurality of images, wherein the face annotation of the image of the member of the household stored in the remote database is one of the face annotations of the recognized common faces in the plurality of images.

13. The method of claim 12, further comprising generating a caption for each image of the plurality of images by a separate artificial intelligence model, wherein the caption of the image of the member of the household stored in the remote database is one of the captions generated by the separate artificial intelligence model.

14. The method of claim 12, wherein the face annotation comprises an identifier of the member of the household and coordinates of a region of the image, the region of the image including an image of the face of the member of the household.

15. The method of claim 14, wherein decompressing the image of the member of the household from the face annotation and the caption comprises inputting the caption into the generative neural network and decompressing the region of the image using the generative neural network.

16. The method of claim 12, wherein the face annotation of the image of the member of the household stored in the remote database comprises coordinates of a region of the image, the region of the image including an image of the face of the member of the household, further comprising calculating loss metrics of the image prior to compressing the image, wherein the calculated loss metrics comprise average loss in image as a whole and local loss in the region of the image including the image of the face of the member of the household.

17. The method of claim 10, wherein compressing the image comprises using the deep image compression to reduce the file size of the image, followed by encoding the image, and wherein decompressing the image of the member of the household using the generative neural network comprises decoding the image, applying a caption to the decoded image, and inputting the caption and the decoded image into the generative neural network.

18. The method of claim 10, wherein household comprises a household appliance, the method further comprising:
obtaining, with a camera assembly of the household appliance, an image of a user at the household appliance;
comparing the decompressed image with the obtained image; and
recognizing the user at the household appliance as the member of the household based on the comparison of the decompressed image with the obtained image.
